(19) United States
(12) Patent Application Publication
(10) Pub. No.: US 2014/0022808 A1
(43) Pub. Date: Jan. 23, 2014

(54) LED Light Module for Vehicle

(71) Applicant: Kwun Wah Chan, Walnut, CA (US)

(72) Inventor: Kwun Wah Chan, Walnut, CA (US)

(21) Appl. No.: 13/552,653

(22) Filed: Jul. 19, 2012

(51) Int. Cl. F21V 7/00

(52) U.S. Cl. 362/516

(57) ABSTRACT

A LED light module for a vehicle includes a reflective light frame having an elongated light reflective channel, a LED light assembly supported along the light reflective channel for generating light along the light reflective channel to provide an even light intensity distribution therealong, and a light diffusion holder enclosing the LED light assembly within the light reflective channel, wherein the light diffusion holder diffuses the lights at the light reflective channel to generate a uniform light effect along the light diffusion holder.

### BACKGROUND

1. Field of the Invention

The present invention relates to a vehicle light assembly. More particularly, the present invention relates to a LED light module for a vehicle, which is a rigid, non-fragile and compact to generate a uniform light effect.

2. Discussion of the Related Art

It is conventional to provide the exterior of a vehicle with lighting devices. Halogen light is generally utilized in vehicle light system including tail light, brake light, stop light, etc. The halogen light generally comprises a replaceable halogen bulb plugged into a bulb socket. The halogen bulb is made of a sealed glass tube filled within an inert gas and a small amount of halogen gas, and a filament received in the glass tube, wherein the halogen bulb can produce a high intensity light and a uniform light effect along the glass tube. However, the halogen bulb will generate heat. Because the halogen light operates at very high temperatures, the vehicle light system must incorporate with some sorts of heat insulated structure to prevent burn hazards. The disadvantages of the halogen light are that the life cycle of the halogen bulb is short, the glass tube is too fragile that the glass tube requires special handling and packaging, and the halogen bulb is energy consuming.

Cold-cathode fluorescent lamp (CCFL) is another common light module used for vehicle light system, wherein CCFL uses a discharge in mercury vapor to develop ultraviolet light, which in turn causes a fluorescent coating on the inside of the glass tube to emit visible light. Similar to the halogen light, CCFL can produce a high intensity light and a uniform light effect along the glass tube. The energy efficiency and the life cycle of CCFL are better than the energy efficiency and the life cycle of halogen light. However, the glass tube is also too fragile that the glass tube requires special handling and packaging. Cold starts and low temperature performance are also the disadvantages of the CCFL. The shape of CCFL is also limited by its glass tube.

LED light modules are one of the most popular enthusiasts do to the vehicle light system. The LED light module generally comprises a plurality of spaced LEDs affixed on a light base. The main advantages of LED light modules are high energy efficiency, extremely long service life, and low heat generation comparing with halogen light and CCFL. The LED light modules have good environmental performance including high temperature and high humidity resistance. Because each LED comprises a solidstate chip embedded in epoxy, each LED is hard to break or burn out. Because the LEDs are spaced apart each other, the LED light module can only produce a plurality of spot lights but not produce an uniform light effect. Therefore, people will see lots of bright dots at the LED light module.

### BRIEF SUMMARY OF THE INVENTION

The present invention overcomes the above mentioned drawbacks and limitation by incorporating a LED light module for a vehicle, which is a simple, compact and inexpensive device.

The primary objective of the present invention is that the LED light module is a rigid, non-fragile, compact, and CCFL-like module to generate a uniform light effect, wherein no bright dot will be seen as the conventional LED light module.

Another objective of the present invention is that the LED light module can be configured to any shape, such as a ring shape to generate a prefect circular uniform light effect.

Another objective of the present invention is that the LED light module is designed to be user-friendly. The LED light module is readily available, and inexpensive in manufacturing cost. Advantages include a requirement of very small power consumption, ease of installation, and extremely thin structure.

Another objective of the present invention is that the LED light module contains the advantages of high energy efficiency, extremely long service life, and low heat generation.

Another objective of the present invention is that the LED light module is compatible with any CCFL light for vehicle.

The LED light module of the instant invention comprises a reflective light frame, a LED light assembly, and a light diffusion holder.

The reflective light frame comprises a reflective bottom wall and two reflective sidewalls to form an elongated light reflective channel, wherein the light reflective channel has a uniform width and depth.

The LED light assembly comprises a circuit frame supported along the light reflective channel and a plurality of spaced apart LED light units electrically coupled at the circuit frame and located between the reflective bottom wall and the circuit frame, wherein when the LED light units are electrified, the LED light units generates lights along the light reflective channel to provide an even light intensity distribution therealong.

The light diffusion holder encloses the LED light assembly within the light reflective channel, wherein the light diffusion holder diffuses the lights at the light reflective channel to generate a uniform light effect along the light diffusion holder.

Accordingly, the LED light assembly is embedded in the light diffusion holder and is entirely protected by the light diffusion holder.

Specifically, the light diffusion holder has a holding channel indented at the bottom side, wherein the LED light assembly is held at the holding channel of the light diffusion holder, so that the LED light assembly is embedded at the bottom side of the light diffusion holder.

Most importantly, the bottom portion of the light diffusion holder is received at the light reflective channel of the reflective light frame between the reflective sidewalls thereof to support the LED light assembly at the light reflective channel of the reflective light frame. The LED light units are suspended and supported at the light reflective channel without touching the reflective bottom wall.

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic view of a LED light module for a vehicle in accordance with the presently embodiment of the invention.

FIG. 2 is a sectional view of the LED light module at a longitudinal direction in accordance with the presently embodiment of the invention.

FIG. 3 is a sectional view of the LED light module at a transverse direction in accordance with the presently embodiment of the invention.

FIG. 4 is shows an alternative shape of the light reflective frame of the LED the light module in accordance with the presently embodiment of the invention.

### DETAILED DESCRIPTION OF THE INVENTION

In accordance with a preferred embodiment of the present invention, the present invention provides a LED light module replaceably mounted to a vehicle to electrically connect the light module to a power source of the vehicle. The LED light module 100 of the invention can be utilized as the lighting system of the exterior of the vehicle such as tail light, brake light, stop light, etc. The LED light module 100 of the invention can form the decorative light for the vehicle.

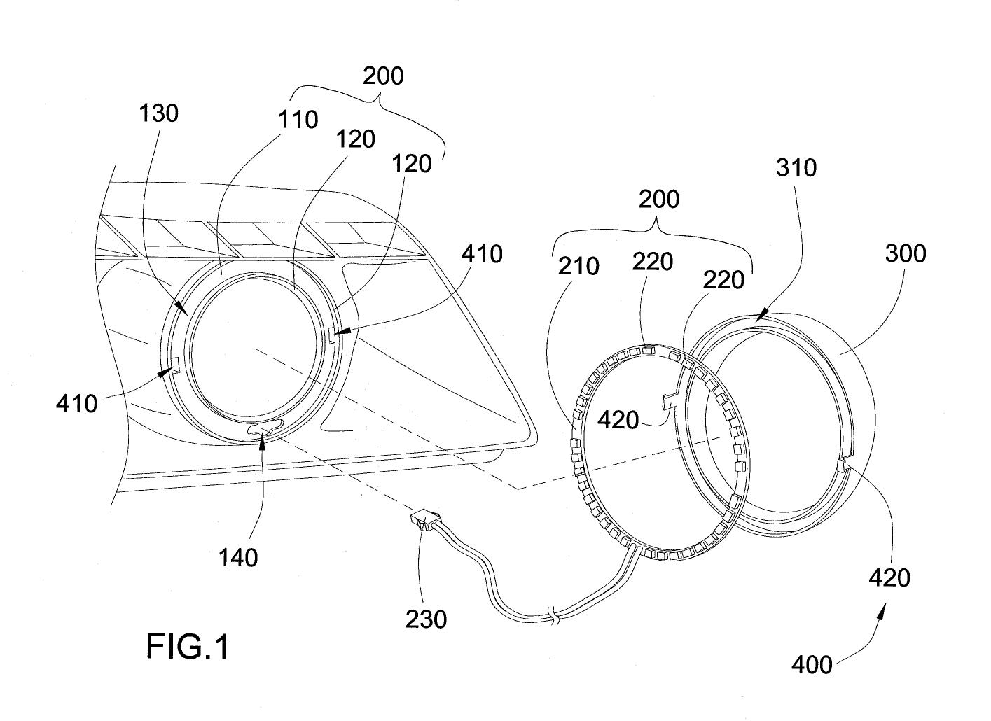

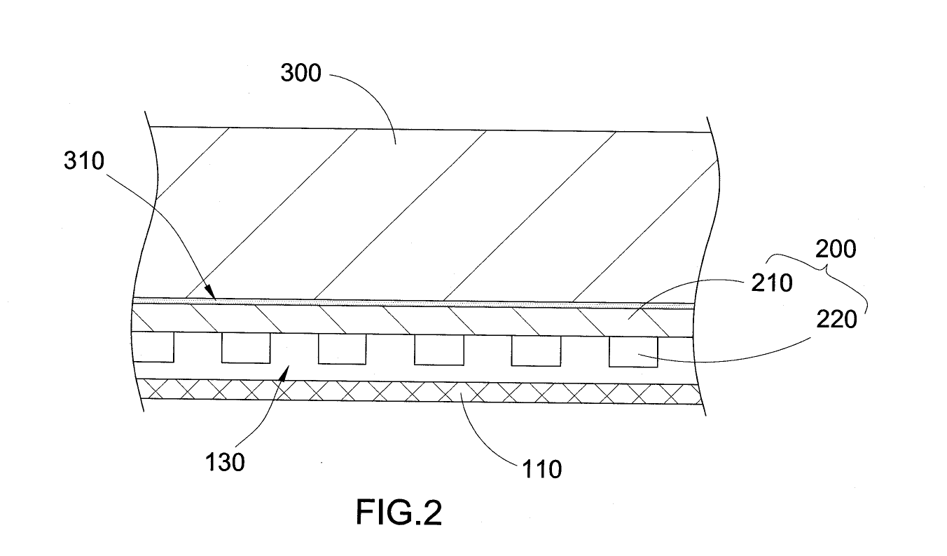

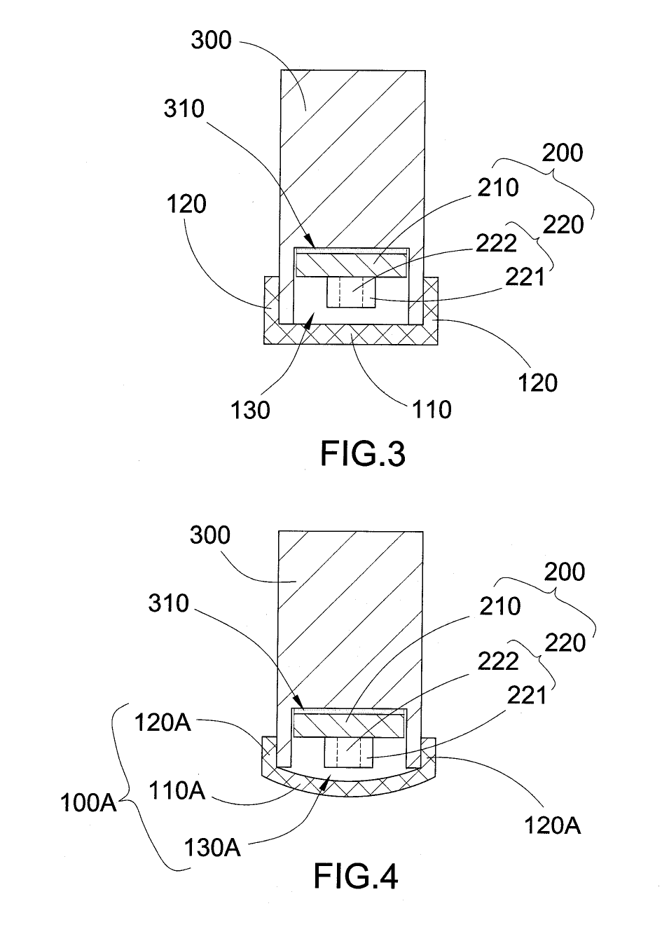

FIGS. 1 to 3 depict the LED light module as a presently embodiment, wherein the LED light module comprises a reflective light frame 100, a LED light assembly 200, and a light diffusion holder 300. In FIG. 1, the LED light module is formed in a ring shape for use in a headlamp of the vehicle.

The reflective light frame 100 is formed at a part of a light casing 10 which is mounted to the vehicle. The light casing 10 can be a headlight assembly or taillight assembly of the vehicle. The reflective light frame 100 comprises a reflective bottom wall 110 and two reflective sidewalls 120 to form an elongated light reflective channel 130.

The LED light assembly 200 comprises a circuit frame 210 supported along the light reflective channel 130 and a plurality of spaced apart LED light units 220 electrically coupled at the circuit frame 210, wherein the LED light units 220 are located between the reflective bottom wall 110 and the circuit frame 210, such that the circuit frame 210 covers the LED light units 220 within the light reflective channel 130. When the LED light units 220 are electrified, the LED light units 220 generate lights along the light reflective channel 130 to provide an even light intensity distribution therealong.

The light diffusion holder 300 encloses the LED light assembly 200 within the light reflective channel 130, wherein the light diffusion holder 300 diffuses the lights at the light reflective channel 130 to generate a uniform light effect along the light diffusion holder 300.

In the presently embodiment, the reflective light frame 100 is formed in a circular shape, wherein the two reflective sidewalls 120 form an inner circular wall and an outer circular wall respectively. The light reflective channel 130 has a U-shaped cross section, wherein the reflective bottom wall 110 has a flat surface and the reflective sidewalls 120 are perpendicular to the reflective bottom wall 110. The light reflective channel 130 is formed in a non-straight channel that the light reflective channel 130 can be a curving channel or an irregular shaped channel. The light reflective channel 130 can also be configured to have an alphabet shape or numerical shape. Preferably, the light reflective channel 130 has a uniform depth as well.

The LED light assembly 200 is configured to match the shape of the reflective light frame 100. The circuit frame 210 is configured in a predetermined shape matching with the shape of the light reflective channel 130. The circuit frame 210 is made of light blocking material so that the lights from the LED light units 220 will be blocked by the circuit frame 210 directly projected out of the light reflective channel 130.

A width of the circuit frame 210 is smaller than a distance between the reflective sidewalls 120 which is a width of the light reflective channel 130. When the circuit frame 210 is supported within the light reflective channel 130, the lights from the LED light units 220 can be projected to the reflective bottom wall 110 and the reflective sidewalls 120. The circuit frame 210 has a bottom side and a top side.

The LED light units 220 are spaced apart and electrically coupled at the bottom side of the circuit frame 210, so that the bottom side of the circuit frame 210 forms a LED side to retain the LED light units 220 in position. Particularly, no light can be penetrated from the bottom side of the circuit frame 210 to the top side thereof because the circuit frame 210 is made of non-light transmissible material.

The LED light units 220 are aligned at a centerline of the light reflective channel 130 between the reflective sidewalls 120. Each of the LED light units 220 comprises a diode casing 221 coupled at the bottom side of the circuit frame 210 and a diode 222 being housed at the diode casing 221 to electrically couple at the bottom side of the circuit frame 210, wherein lights from the diodes 222 are generated toward the light reflective channel 130 to enhance the light intensity at the light reflective channel 130.

Preferably, each diode 222 is a high intensity diode, wherein when the diodes 222 are supported at the light reflective channel 130, the diodes 222 are suspended from the reflective bottom wall 110 so that the diodes 222 will not touch the reflective bottom wall 110. The diodes 222 can be configured to provide a desired color such as yellow light, red light or white light depending on the type selection of the diode 222. A desired light pattern of the diodes 222 can be controlled by the circuit frame 210, such as flashing, depending on the use of the vehicle light.

The LED light assembly 200 further comprises an electrical cable 230 electrically extended from the circuit frame 210. The reflective light frame 100 further has a cable slot 140 formed at the reflective bottom wall 110 to guide the electrical cable 230 passing through the cable slot 140 for electrical connection.

In the presently embodiment, the light diffusion holder 300 is made of insulated material and is constructed in a non-hollow configuration. Particular, the light diffusion holder 300 is a solid member and is made of translucent and durable material. It is preferred that the light diffusion holder 300 is made of epoxy and the thickness of the light diffusion holder 300 can be varied. In the presently embodiment, the thickness of the light diffusion holder 300, which is the distance between the top and bottom sides of the light diffusion holder 330, is gradually increase.

The light diffusion holder 300 is preferred to be made by mold injection so that the shape of the light diffusion holder 300 can be altered. In FIG. 1, the light diffusion holder 300 is configured to have a ring shape matching with the shape of the reflective light frame 100. It is preferred that the top and bottom sides of the light diffusion holder 300 are two flat surfaces.

The light diffusion holder 300 has a holding channel 310 indented at a bottom side of the light diffusion holder 300, wherein the LED light assembly 200 is held at the holding channel 310 of the light diffusion holder 300.

The top side of the circuit frame 210 forms an adhering side which is adhered to a ceiling of the holding channel 310 of the light diffusion holder 300, so that the LED light units 220 are electrically coupled at the LED side of the circuit frame 210 facing toward the reflective bottom wall 110 of the reflective light frame 100.

The width of the light diffusion holder 300 matches with the width of the light reflective channel 130. The bottom portion of the light diffusion holder 300 is received at the light reflective channel 130 of the reflective light frame 100 between the reflective sidewalls 120 thereof to support the LED light assembly 200 at the light reflective channel 130 of the reflective light frame 100. Therefore, the light diffusion holder 300 provides multiple functions of holding the LED light assembly 200 at the light reflective channel 130 and diffusing the light from the LED light assembly 220 out of the light reflective channel 130.

When the bottom portion of the light diffusion holder 300 is received at the light reflective channel 130, the bottom side of the light diffusion holder 300 will contact with the reflective bottom wall 110 of the reflective light frame 100. Therefore, the lights from the LED light units 220 will either penetrate through the holding channel 310 to the reflective sidewalls 120 or be directly reflected by the reflective bottom wall 110 and back to the light diffusion holder 300. All the lights will be projected out of the light reflective channel 130 through the light diffusion holder 300.

The overall thickness of the LED light assembly 200 is smaller than the depth of the holding channel 130. Therefore, when the LED light assembly 200 is held within the holding channel 310, the LED light units 220 of the LED light assembly 200 are supported at the light reflective channel 130 without touching the reflective bottom wall 110 of the reflective light frame 100. The overall thickness of the LED light assembly 200 is the sum of the thickness of the circuit frame 210 and the thickness of each of the LED light units 220.

Therefore, when the LED light units 220 are electrified, the light diffusion holder 300 will diffuse the lights from the light reflective channel 130 to generate a perfect circular uniform light effect so as to provide the most aesthetically appealing appearance. Unlike the CCFL, the glass tube of CCFL cannot be bent in a ring shape, wherein the glass tube of CCFL can only be bent in imperfect circular shape with an opening gap between two ends so that CCFL cannot generate the perfect circular uniform light effect as illustrated in the invention.

In the presently embodiment, the LED light units 220 are positioned close enough that the light projection angles of the diodes 222 overlaps with each other to generate enough light intensity with the light reflective channel 130. The light reflective channel 130 will reflect the lights from the diodes 222 to provide an even light intensity distribution therealong. Then, the light diffusion holder 300 will diffuse the light from the light reflective channel 130 to create the uniform light effect similar to the CCFL light effect. Therefore, there is no bright dot to be seen at the light diffusion holder 300 when the diodes 222 are electrified to generate lights.

The LED light module further comprises means for attaching the light diffusion holder 300 to the reflective light frame 100. The attachment means 400 comprises an attachment slot 410 formed at the reflective bottom wall 110 of the reflective light frame 100 and an attachment latch 420 integrated with and extended from the bottom side of the light diffusion holder 300 to couple with the attachment slot 410. The attachment latch 420 is also made of translucent material same as the light diffusion holder 300 so that the attachment latch 420 will not block any light within the light reflective channel 130. The attachment latch 420 also has a locking end extended through the attachment slot 410 to engage with the rear side of the reflective bottom wall 110 of the light reflective frame 100.

FIG. 4 shows a modification of the reflective light frame 100A which comprises a reflective bottom wall 110A and two reflective sidewalls 120A to form an elongated light reflective channel 130A. The structural configuration of the reflective light frame 110A is the same as the presently embodiment of the reflective light frame 110 except the light reflective channel 130A having a U-shaped cross section, wherein the reflective bottom wall 110A has a curved surface.

Because of the curving bottom wall 110A of the reflective light frame 110A, the depth of the holding channel 310 can be configured equal to the overall thickness of the LED light assembly 200. Therefore, when the LED light assembly 200 is held within the holding channel 310, the LED light units 220 of the LED light assembly 200 are supported at the light reflective channel 130A without touching the reflective bottom wall 110A of the reflective light frame 100A.

It should be appreciated that the LED light module can also be configured for using as a light sign. When the light diffusion holder 300 is also made of fluorescent material, the LED light module will generate a neon light effect.

It should be appreciated that the LED light module can be configured in any shape without any limitation of the light diffusion holder 300. The LED light module of the invention can be formed at any shape, even the irregular shape, such as symbol shape, numerical shape or alphabetical shape, to provide the uniform light effect. The LED light assembly 200 is embedded in the light diffusion holder 300 and is entirely protected by the light diffusion holder 300. Therefore, the LED light module can be used indoors or outdoors. The LED light units 220 are manufactured in low cost and the manufacturing process of the LED light assembly 200 is simple and inexpensive. Therefore, the LED light module can be manufactured in low cost. The LED light module is a rigid, non-fragile, compact, and CCFL-like/neon-like module to generate a uniform light effect, wherein no bright dot will be seen as the conventional LED light module.

While the embodiments and alternatives of the invention have been shown and described, it will be apparent to one skilled in the art that various other changes and modifications can be made without departing from the spirit and scope of the invention.

What is claimed is:

1. A LED light module for a vehicle, comprising:
a reflective light frame which comprises a reflective bottom wall and two reflective sidewalls to form an elongated light reflective channel;
a LED light assembly which comprises a circuit frame supported along said light reflective channel and a plurality of spaced apart LED light units electrically coupled at said circuit frame and located between said reflective bottom wall and said circuit frame, wherein when said LED light units are electrified, said LED light units generate lights along said light reflective channel to provide an even light intensity distribution therealong; and
a light diffusion holder enclosing said LED light assembly within said light reflective channel, wherein said light diffusion holder diffuses said lights at said light reflective channel to generate a uniform light effect along said light diffusion holder.

2. The LED light module of claim 1 wherein said light diffusion holder, which is a solid member, has a holding channel indented at a bottom side of said light diffusion holder, wherein said LED light assembly is held at said holding channel of said light diffusion holder.

3. The LED light module of claim 2 wherein a bottom portion of said light diffusion holder is received at said light reflective channel of said reflective light frame between said reflective sidewalls thereof to support said LED light assembly at said light reflective channel of said reflective light frame.

4. The LED light module of claim 3 wherein said bottom portion of said light diffusion holder is received at said light reflective channel at a position that said bottom side of said light diffusion holder contacts with said reflective bottom wall of said reflective light frame.

5. The LED light module of claim 2 wherein said light diffusion holder is made of translucent and durable material.

6. The LED light module of claim 4 wherein said light diffusion holder is made of translucent and durable material.

7. The LED light module of claim 5 wherein an overall thickness of said LED light assembly equals to or is smaller than a depth of said holding channel.

8. The LED light module of claim 6 wherein an overall thickness of said LED light assembly equals to or is smaller than a depth of said holding channel.

9. The LED light module of claim 2 wherein when said LED light assembly is held within said holding channel, said LED light units of said LED light assembly are supported at said light reflective channel without touching said reflective bottom wall of said reflective light frame.

10. The LED light module of claim 8 wherein when said LED light assembly is held within said holding channel, said LED light units of said LED light assembly are supported at said light reflective channel without touching said reflective bottom wall of said reflective light frame.

11. The LED light module of claim 9 wherein said circuit frame has a LED side and an opposed adhering side, wherein said LED light units are electrically coupled at said LED side facing toward said reflective bottom wall of said reflective light frame, wherein said adhering side of said circuit frame is adhered to a ceiling of said holding channel of said light diffusion holder.

12. The LED light module of claim 10 wherein said circuit frame has a LED side and an opposed adhering side, wherein said LED light units are electrically coupled at said LED side facing toward said reflective bottom wall of said reflective light frame, wherein said adhering side of said circuit frame is adhered to a ceiling of said holding channel of said light diffusion holder.

13. The LED light module of claim 2 wherein said light diffusion holder is coupled with said reflective light frame via an attachment means, wherein said attachment means comprises an attachment slot formed at said reflective bottom wall of said reflective light frame and an attachment latch integrated with and extended from said bottom side of said light diffusion holder to couple with said attachment slot.

14. The LED light module of claim 12 wherein said light diffusion holder is coupled with said reflective light frame via an attachment means, wherein said attachment means comprises an attachment slot formed at said reflective bottom wall of said reflective light frame and an attachment latch integrated with and extended from said bottom side of said light diffusion holder to couple with said attachment slot.

15. The LED light module of claim 1 wherein each of LED light units comprises a diode casing coupled at said circuit frame and a diode being housed at said diode casing to electrically couple at said circuit frame, wherein lights from said diodes are generated toward said light reflective channel.

16. The LED light module of claim 14 wherein each of LED light units comprises a diode casing coupled at said circuit frame and a diode being housed at said diode casing to electrically couple at said circuit frame, wherein lights from said diodes are generated toward said light reflective channel.

17. The LED light module of claim 16 wherein said light reflective channel is a non-straight channel, wherein said circuit frame of said LED light assembly is configured in a predetermined shape matching with a shape of said light reflective channel.

18. The LED light module of claim 16 wherein said light reflective channel has a U-shaped cross section, wherein said reflective bottom wall has a flat surface and said reflective sidewalls are perpendicular to said reflective bottom wall.

19. The LED light module of claim 16 wherein said light reflective channel has a U-shaped cross section, wherein said reflective bottom wall has a curved surface.

20. The LED light module of claim 16 wherein said LED light assembly further comprises an electrical cable electrically extended from said circuit frame, wherein said reflective light frame further has a cable slot formed at said reflective bottom wall to guide said electrical cable passing through said cable slot for electrical connection.
